(19) United States
(12) Patent Application Publication
(10) Pub. No.: US 2008/0275713 A9
(43) Pub. Date: Nov. 6, 2008

(54) Architectural design for physical inventory application software

(76) Inventors: Shai Alfandary, Zur Moshe (IL); Jochen Hirth, Birkenau (DE); Martin J. Wilmes, Oftersheim (DE); Jens Freund, Heidelberg (DE); Stefan Kaetker, Dossenheim (DE); Gerd Moosmann, Pforzheim (DE); Peter Latocha, Malsch (DE)

Correspondence Address: FISH & RICHARDSON, P.C., PO BOX 1022, MINNEAPOLIS, MN, 55440-1022, US

(21) Appl. No.: 11/322,973

(22) Filed: Dec. 30, 2005

(51) Int. Cl. G06Q 99/00

(52) U.S. Cl. 705/1

(57) ABSTRACT

Methods, systems, and apparatus, including computer program products, for implementing a software architecture design for a software application implementing physical inventory. The application is structured as multiple process components interacting with each other through service interfaces, and multiple service interface operations, each being implemented for a respective process component. The process components include an Accounting process component that records relevant business transaction; a Physical Inventory Processing process that manages the execution of inventory counting within a logistic site, from the request for counting operation, through the actual inventory counting results gathering and its final confirmation; a Confirmation and Inventory process component that combines the tasks required to confirm inventory changes and provided activities; and a Supply and Demand Matching process component that combines the tasks necessary to ensure that sufficient material receipt elements exist to cover material demand while taking available capacity into account.

### BACKGROUND

The subject matter of this patent application relates to computer software architecture, and more particularly to the architecture of application software for physical inventory.

Enterprise software systems are generally large and complex. Such systems can require many different components, distributed across many different hardware platforms, possibly in several different geographical locations. Thus, the architecture of a large software application, i.e., what its components are and how they fit together, is an important aspect of its design for a successful implementation.

### SUMMARY

This specification presents a software architecture design for a software application.

The present invention can be implemented as methods, systems, and apparatus, including computer program products, for implementing a software architecture design for a software application implementing physical inventory. The application is structured as multiple process components interacting with each other through service interfaces, and multiple service interface operations, each being implemented for a respective process component. The process components include an Accounting process component that records relevant business transaction; a Physical Inventory Processing process that manages the execution of inventory counting within a logistic site, from the request for counting operation, through the actual inventory counting results gathering and its final confirmation; a Confirmation and Inventory process component that combines the tasks required to confirm inventory changes and provided activities; and a Supply and Demand Matching process component that combines the tasks necessary to ensure that sufficient material receipt elements exist to cover material demand while taking available capacity into account.

The subject matter described in this specification can be implemented to realize one or more of the following advantages. Effective use is made of process components as units of software reuse, to provide a design that can be implemented reliably in a cost effective way. Effective use is made of deployment units, each of which is deployable on a separate computer hardware platform independent of every other deployment unit, to provide a scalable design. Service interfaces of the process components define a pair-wise interaction between pairs of process components that are in different deployment units in a scalable way.

Details of one or more implementations of the subject matter described in this specification are set forth in the accompanying drawings and in the description below. Further features, aspects, and advantages of the subject matter will become apparent from the description, the drawings, and the claims.

### BRIEF DESCRIPTION OF THE DRAWINGS

FIG. 1 is a block diagram of a software architectural design for a physical inventory software application.

FIG. 2 illustrates the elements of the architecture as they are drawn in the figures of this patent application.

FIG. 3 is a block diagram showing interactions between a Confirmation and Inventory process component and an Accounting process component.

FIG. 4 is a block diagram showing interactions between a Confirmation and Inventory process component and a Supply and Demand Matching process component.

Like reference numbers and designations in the various drawings indicate like elements.

### DETAILED DESCRIPTION

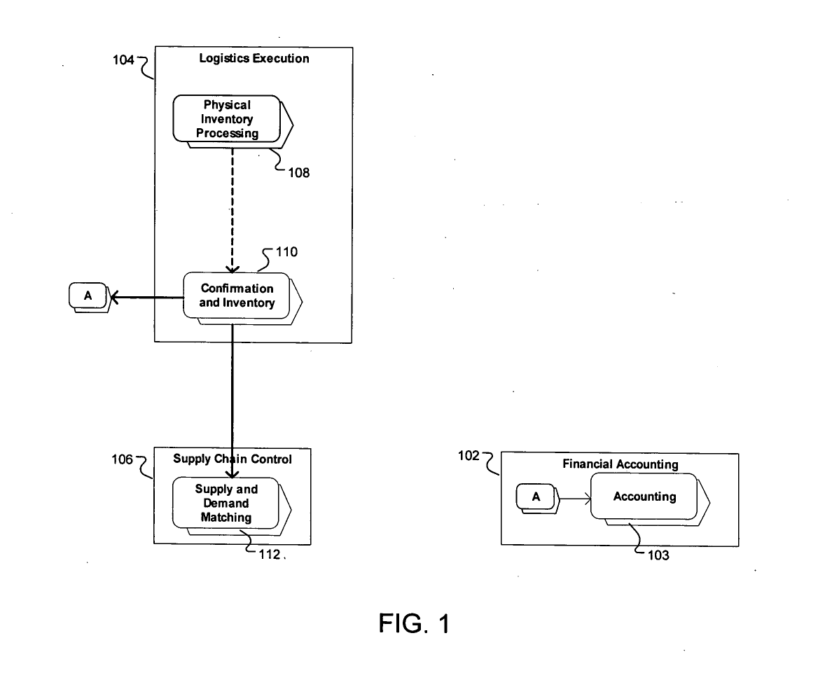

FIG. 1 shows the software architectural design for a physical inventory software application. The physical inventory application is software that implements an end-to-end process used to check the actual physical stock levels and correct the stock levels captured in the system.

As shown in FIG. 1, the physical inventory design includes three deployment units: a Financial Accounting unit 102, a Logistics Execution unit 104 and a Supply Chain Control unit 106.

The Financial Accounting deployment unit 102 contains an Accounting process component 103 that records all relevant business transactions.

The Logistics Execution deployment unit 104 includes two process components: a Physical Inventory Processing process component 108 and a Confirmation and Inventory process component 110. The Physical Inventory Processing process component 108 manages the execution of inventory counting within a logistic site, from the request for counting operation, through the actual inventory counting results gathering and its final confirmation. The Confirmation and Inventory process component 110 combines all the tasks required to confirm inventory changes and provided activities. The process component 110 provides services to maintain current stock, handling unit content and allocations.

The Supply Chain Control deployment unit 106 includes a Supply and Demand Matching process component 112. The Supply and Demand Matching process component 112 combines all the tasks necessary to ensure that sufficient material receipt elements exist to cover material demand while taking available capacity into account. The Supply and Demand Matching process component 112 collects all the various material demands from customer requirement processing, in house requirement processing, demand forecast processing, and sales scheduling agreement processing.

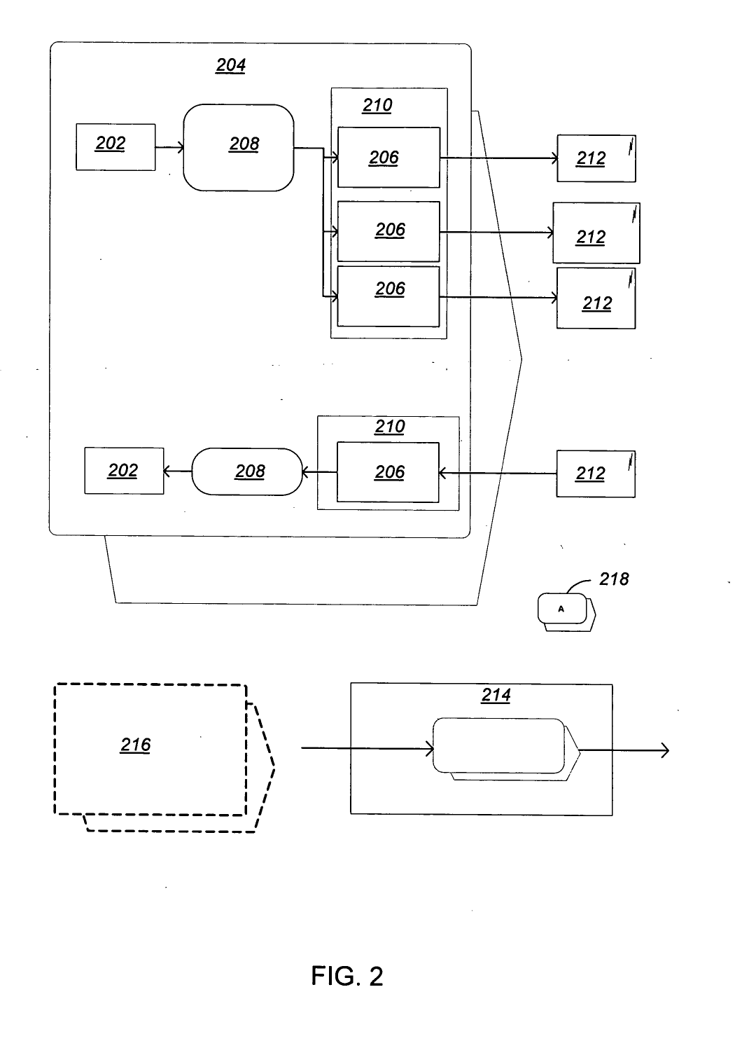

FIG. 2 illustrates the elements of the architecture as they are drawn in the figures of this patent application. The elements of the architecture include the business object (drawn as icon 202), the process component (drawn as icon 204), the operation (drawn as icon 206), the process agent (drawn as icon 208), the service interface or interface (drawn as icon 210), the message (drawn as icon 212), and the deployment unit (drawn as icon 214).

Not explicitly represented in the figures is a foundation layer that contains all fundamental entities that are used in multiple deployment units. These entities can be process components, business objects and reuse service components. A reuse service component is a piece of software that is reused in different transactions. A reuse service component is used by its defined interfaces, which can be, e.g., local APIs (Application Programming Interfaces) or service interfaces.

In contrast to a deployment unit, the foundation layer does not define a limit for application-defined transactions. Deployment units communicate directly with entities in the foundation layer, which communication is typically not message based. The foundation layer is active in every system instance on which the application is deployed. Business objects in the foundation layer will generally be master data objects. In addition, the foundation layer will include some business process objects that are used by multiple deployment units. Master data objects and business process objects that should be specific to a deployment unit are assigned to their respective deployment unit.

A process component of an external system is drawn as a dashed-line process component (drawn as icon 216). Such a process component is used to represent the external system in describing interactions with the external system; however, this should be understood to require no more of the external system that it be able to produce and receive messages as required by the process component that interacts with the external system.

The connector icon 218 is used to simplify the drawing of interactions between process components.

Interactions between process component pairs involving their respective business objects, process agents, operations, interfaces, and messages are described as process component interactions, which determine the interactions of a pair of process components across a deployment unit boundary, i.e., from one deployment unit to another deployment unit. Interactions between process components are indicated in FIG. 1 by directed lines (arrows). Interactions between process components within a deployment unit need not be described except to note that they exist, as these interactions are not constrained by the architectural design and can be implemented in any convenient fashion. Interactions between process components that cross a deployment unit boundary will be illustrated by the figures of this patent application; these figures will show the relevant elements associated with potential interaction between two process components, but interfaces, process agents, and business objects that are not relevant to the potential interaction will not be shown.

The architectural design is a specification of a computer software application, and elements of the architectural design can be implemented to realize a software application that implements the end-to-end process mentioned earlier. The elements of the architecture are at times described in this specification as being contained or included in other elements; for example, a process component is described as being contained in a deployment unit. It should be understood, however, that such operational inclusion can be realized in a variety of ways and is not limited to a physical inclusion of the entirety of one element in another.

The architectural elements include the business object. A business object is a representation of a type of a uniquely identifiable business entity (an object instance) described by a structural model. Processes operate on business objects.

A business object represents a specific view on some well-defined business content. A business object represents content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). The term business object will be used generically to refer to a business process object and a master data object, unless the context requires otherwise. Properly implemented, business objects are implemented free of redundancies.

The architectural elements also include the process component. A process component is a software package that realizes a business process and generally exposes its functionality as services. The functionality contains business transactions. A process component contains one or more semantically related business objects. Any business object belongs to no more than one process component.

Process components are modular and context-independent. That they are context-independent means that a process component is not specific to any specific application and is reusable. The process component is the smallest (most granular) element of reuse in the architecture.

The architectural elements also include the operation. An operation belongs to exactly one process component. A process component generally has multiple operations. Operations can be synchronous or asynchronous, corresponding to synchronous or asynchronous process agents, which will be described below. An operation is the smallest, separately-callable function, described by a set of data types used as input, output, and fault parameters serving as a signature.

The architectural elements also include the service interface, referred to simply as the interface. An interface is a named group of operations. Each operation belongs to exactly one interface. An interface belongs to exactly one process component. A process component might contain multiple interfaces. In one implementation, an interface contains only inbound or outbound operations, but not a mixture of both. One interface can contain both synchronous and asynchronous operations. All operations of the same type (either inbound or outbound) which belong to the same message choreography will belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. An operation can use multiple message types for inbound, outbound, or error messages. When two process components are in different deployment units, invocation of an operation of one process component by the other process component is accomplished by an operation on the other process component sending a message to the first process component.

The architectural elements also include the process agent. Process agents do business processing that involves the sending or receiving of messages. Each operation will generally have at least one associated process agent. A process agent can be associated with one or more operations. Process agents can be either inbound or outbound, and either synchronous or asynchronous.

Asynchronous outbound process agents are called after a business object changes, e.g., after a create, update, or delete of a business object instance.

Synchronous outbound process agents are generally triggered directly by a business object.

An output process agent will generally perform some processing of the data of the business object instance whose change triggered the event. An outbound agent triggers subsequent business process steps by sending messages using well-defined outbound services to another process component, which generally will be in another deployment unit, or to an external system. An outbound process agent is linked to the one business object that triggers the agent, but it is sent not to another business object but rather to another process component. Thus, the outbound process agent can be implemented without knowledge of the exact business object design of the recipient process component.

Inbound process agents are called after a message has been received. Inbound process agents are used for the inbound part of a message-based communication. An inbound process agent starts the execution of the business process step requested in a message by creating or updating one or multiple business object instances. An inbound process agent is not the agent of a business object but of its process component. An inbound process agent can act on multiple business objects in a process component.

Synchronous agents are used when a process component requires a more or less immediate response from another process component, and is waiting for that response to continue its work.

Operations and process components are described in this specification in terms of process agents. However, in alternative implementations, process components and operations can be implemented without use of agents using other conventional techniques to perform the functions described in this specification.

The architectural elements also include the deployment unit. A deployment unit includes one or more process components that are deployed together on a single computer system platform. Conversely, separate deployment units can be deployed on separate physical computing systems. For this reason, a deployment unit boundary defines the limits of an application-defined transaction, i.e., a set of actions that have the ACID properties of atomicity, consistency, isolation, and durability. To make use of database manager facilities, the architecture requires that all operations of such a transaction be performed on one physical database; as a consequence, the processes of such a transaction must be performed by the process components of one instance of one deployment unit.

The process components of one deployment unit interact with those of another deployment unit using messages passed through one or more data communication networks or other suitable communication channels. Thus, a deployment unit deployed on a platform belonging one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by a deployment unit to be scaled to meet demand by creating as many instances as needed.

Since interaction between deployment units is through service operations, a deployment unit can be replaced by other another deployment unit as long as the new deployment unit supports the operations depended upon by other deployment units. Thus, while deployment units can depend on the external interfaces of process components in other deployment units, deployment units are not dependent on process component interaction within other deployment units. Similarly, process components that interact with other process components or external systems only through messages, e.g., as sent and received by operations, can also be replaced as long as the replacement supports the operations of the original.

Interactions Between Process Components “Confirmation and Inventory” and “Accounting”

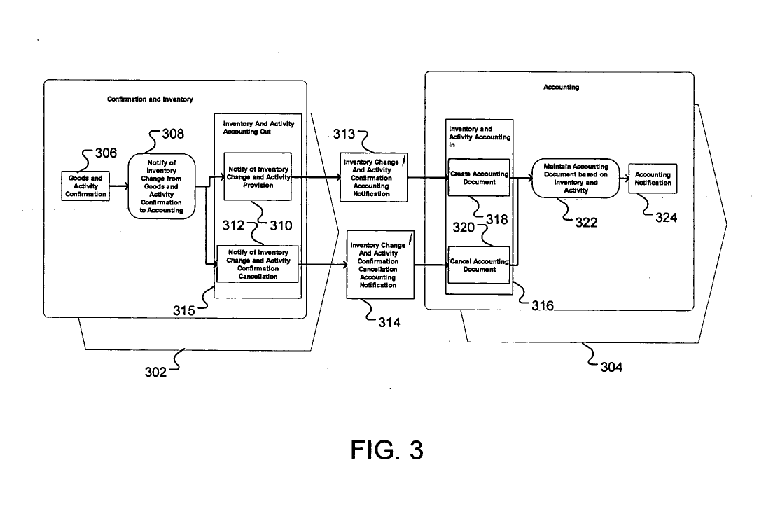

FIG. 3 is a block diagram showing interactions between a Confirmation and Inventory process component 302 and an Accounting process component 304 in the architectural design of FIG. 1. The Confirmation and Inventory process component 302 includes a goods and Activity Confirmation business object 306 that contains all actual data reflecting an ‘ad-hoc’ executed work.

A Notify of Inventory Change from Goods and Activity confirmation to Accounting outbound process agent 308 invokes a Notify of Inventory Change and Activity Provision operation 310 to send an Inventory Change and Activity Confirmation Accounting Notification message 313 to Accounting. Alternatively, a Request Inventory Change and Activity Confirmation Cancellation operation 312 may be invoked to send an Inventory Change and Activity Confirmation Accounting Cancellation Request message 314 to Accounting. Both operations may be used in an Inventory and Activity Accounting Out interface 315.

The messages 313 and 314 are received by an Inventory and Activity Accounting In interface 316 where operations may be performed. If a notification message is received, then a Create Accounting Document operation 318 is performed to Receive Inventory Change Accounting Notifications from the Confirmation and Inventory process component 302. If a cancellation message is received, then a Cancel Accounting Document operation 320 is performed to cancel requests received from the Confirmation and Inventory process component 302. Cancellations and updates may be sent by a Maintain Accounting Document based on Inventory and Activity inbound process agent 322 to the Accounting Notification business object 324.

Interactions Between Process Components “Confirmation and Inventory” and “Supply and Demand Matching”

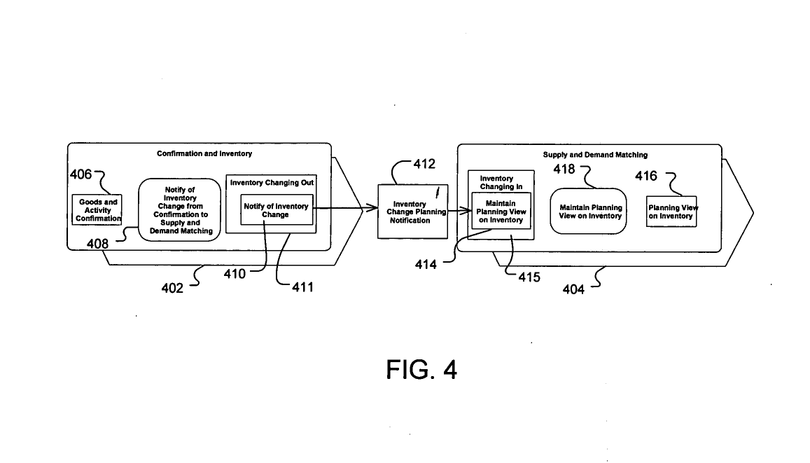

FIG. 4 is a block diagram showing interactions between a Confirmation and Inventory process component 402 and a Supply and Demand Matching process component 404 in the architectural design of FIG. 1.

The Goods and Activity Confirmation business object 406 is included in the Confirmation and Inventory process component 402. The business object 406 may use a Notify of Inventory Change from Confirmation to Supply and Demand Matching outbound process agent 408 to invoke a Notify of Inventory Change operation 410. The operation 410 is part of an Inventory Changing Out interface 411. The Notify of Inventory Change operation 410 sends an Inventory Change Planning Notification message to Supply and Demand Planning. The message 412 is received in a Maintain planning View on Inventory operation 414. The Maintain planning View on Inventory operation 414 is part of an Inventory Changing In interface 415. An update may be sent to a Planning View on Inventory business object 416 using a Maintain Planning View on Inventory inbound process agent 418. The Planning View on Inventory business object 416 represents the inventory object from Logistics Execution.

The subject matter described in this specification and all of the functional operations described in this specification can be implemented in digital electronic circuitry, or in computer software, firmware, or hardware, including the structural means disclosed in this specification and structural equivalents thereof, or in combinations of them. The subject matter described in this specification can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The subject matter described in this specification can be implemented in a computing system that includes a back-end component (e.g., a data server), a middleware component (e.g., an application server), or a front-end component (e.g., a client computer having a graphical user interface or a Web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as an exemplification of preferred embodiments of the invention. Certain features that are described in this specification in the context of separate embodiments, may also be provided in combination in a single embodiment. Conversely, various features that are described in the context of a single embodiment may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter has been described in terms of particular variations, but other variations can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A computer program product comprising application software encoded on a tangible machine-readable information carrier, the application software being structured as process components interacting with each other through service interfaces, the software comprising:
a plurality of process components, each of the process components being a package of software implementing a respective and distinct business process, the plurality of process components including:
an Accounting process component that records relevant business transaction;
a Physical Inventory Processing process that manages the execution of inventory counting within a logistic site, from the request for counting operation, through the actual inventory counting results gathering and its final confirmation;
a Confirmation and Inventory process component that combines the tasks required to confirm inventory changes and provided activities; and
a Supply and Demand Matching process component that combines the tasks necessary to ensure that sufficient material receipt elements exist to cover material demand while taking available capacity into account; and
a plurality of service interface operations, each service interface operation being implemented for a respective process component, the operations comprising inbound and outbound operations, the outbound operation for a first process component being operable to send a message to a second process component of the plurality of process components, the second process component having an inbound operation for receiving the message, the passing of messages between an inbound and an outbound operation defining a message-based pair-wise interaction between the respective process components of the respective operations, the pair-wise interactions between pairs of the process components including interactions between:
the Confirmation and Inventory process component and the Accounting process component; and
the Confirmation and Inventory process component and the Supply and Demand Matching process component.

2. The product of claim 1, wherein:
each of the plurality of process components is assigned to exactly one deployment unit among multiple deployment units, and each deployment unit is deployable on a separate computer hardware platform independent of every other deployment unit; and
all interaction between a process component in one deployment unit and any other process component in any other deployment unit takes place through the respective service interfaces of the two process components.

3. The product of claim 2, wherein the deployment units comprise:
a Financial Accounting deployment unit that includes an Accounting process component;
a Logistics Execution deployment unit that includes a Physical Inventory Processing process component and a Confirmation and Inventory process component; and
a Supply Chain Control deployment unit that includes a Supply and Demand Matching process component.

4. The product of claim 1, wherein:
each of the process components includes one or more business objects; and
none of the business objects of any one of the process components interacts directly with any of the business objects included in any of the other process components.

5. The product of claim 4, wherein the business objects comprise a business process object.

6. The product of claim 4, wherein:
none of the business objects included in any one of the process components is included in any of the other process components.

7. The product of claim 1, further comprising:
a plurality of process agents, each process agent being either an inbound process agent or an outbound process agent, an inbound process agent being operable to receive a message from an inbound operation, an outbound process agent being operable to cause an outbound operation to send a message, each process agent being associated with exactly one process component.

8. The product of claim 7, wherein:
the inbound process agents comprise a first inbound process agent operable to start the execution of step requested in a first inbound message by creating or updating one or more business object instances.

9. The product of claim 7, wherein:
the outbound process agents comprise a first asynchronous outbound process agent that is called after a business object that is associated with the first outbound process agent changes.

10. The product of claim 1, wherein the operations comprise synchronous and asynchronous operations.

11. A system, comprising:
a computer system comprising one or more hardware platforms for executing a computer software application;
a plurality of process components, each of the process components being a package of software implementing a respective and distinct business process, the plurality of process components including:
an Accounting process component that records relevant business transaction;
a Physical Inventory Processing process that manages the execution of inventory counting within a logistic site, from the request for counting operation, through the actual inventory counting results gathering and its final confirmation;
a Confirmation and Inventory process component that combines the tasks required to confirm inventory changes and provided activities; and
a Supply and Demand Matching process component that combines the tasks necessary to ensure that sufficient material receipt elements exist to cover material demand while taking available capacity into account; and
a plurality of service interface operations, each service interface operation being implemented for a respective process component, the operations comprising inbound and outbound operations, the outbound operation for a first process component being operable to send a message to a second process component of the plurality of process components, the second process component having an inbound operation for receiving the message, the passing of messages between an inbound and an outbound operation defining a message-based pair-wise interaction between the respective process components of the respective operations, the pair-wise interactions between pairs of the process components including interactions between:
the Confirmation and Inventory process component and the Accounting process component; and
the Confirmation and Inventory process component and the Supply and Demand Matching process component.

12. The system of claim 11, wherein:
each of the process components includes one or more business objects; and
none of the business objects of any one of the process components interacts directly with any of the business objects included in any of the other process components.

13. The system of claim 11, wherein:
none of the business objects included in any one of the process components is included in any of the other process components.

14. The system of claim 11, wherein:
a plurality of process agents, each process agent being either an inbound process agent or an outbound process agent, an inbound process agent being operable to receive a message from an inbound operation, an outbound process agent being operable to cause an outbound operation to send a message, each process agent being associated with exactly one process component.

15. The system of claim 11, the system comprising multiple hardware platforms, wherein:
the Accounting process component is deployed on a first hardware platform;
the Physical Inventory Processing process component and the Confirmation and Inventory process component are deployed on a second hardware platform; and
the Supply and Demand Matching process component is deployed on a third hardware platform.

16. The system of claim 15, wherein each of the first through the third hardware platforms are distinct and separate from each other.

17. A method for developing a computer software application, comprising:
obtaining in a computer system digital data representing an architectural design for a set of processes implementing an end-to-end application process, the design specifying a process component for each process in the set of processes, the design specifying further specifying a set of process component interactions, wherein
the specified process components include
an Accounting process component that records relevant business transaction;
a Physical Inventory Processing process that manages the execution of inventory counting within a logistic site, from the request for counting operation, through the actual inventory counting results gathering and its final confirmation;
a Confirmation and Inventory process component that combines the tasks required to confirm inventory changes and provided activities; and
a Supply and Demand Matching process component that combines the tasks necessary to ensure that sufficient material receipt elements exist to cover material demand while taking available capacity into account; and
the process component interactions include interactions between
the Confirmation and Inventory process component and the Accounting process component; and
the Confirmation and Inventory process component and the Supply and Demand Matching process component; and
using the design including the specified process components and the specified process component interactions to develop a computer software application to perform the set of processes.

18. The method of claim 17, wherein:
each process in the set of processes is a business process transforming a defined business input into a defined business outcome.

19. The method of claim 18, wherein:
obtaining digital data representing the architectural design further comprises editing the design before using the design.
